(19) United States
(12) Patent Application Publication
(10) Pub. No.: US 2004/0112195 A1
(43) Pub. Date: Jun. 17, 2004

(54) Book trimming machine with combined-motion blades

(76) Inventor: Mario Lorenzi, Padova (IT)

Correspondence Address: LERNER AND GREENBERG, PA, P O BOX 2480, HOLLYWOOD, FL, 33022-2480, US

(21) Appl. No.: 10/473,084

(22) PCT Filed: Mar. 26, 2002
(86) PCT No.: PCT/IT02/00191

(30) Foreign Application Priority Data
Mar. 20, 2001 (IT) PD2001A000075

(51) Int. Cl. B26D 5/08

(52) U.S. Cl. 83/546; 83/98; 83/934

(57) ABSTRACT

The invention is a new book trimming machine comprising trimming blades with combined movement, that is, with an arced movement and a non-circular rotation of the blade. The machine is provided with a central interchangeable pressing device to keep the sheets in horizontal position during trimming. The support table is constituted by two hinged parts with axis parallel to the advance direction of the book. Once the book has been trimmed, said two parts are rotated downwards in order to remove the trimmings. An overturning plane is positioned between the two side parts of the support table and is lifted and aligned with the two side parts of the support table when the blades trim the book. The front part of the conveyor belt that transports the book towards the support table slides around translating rollers, in such a way as to transfer the book onto the support table and then move away to let the trimmings of the book edge opposite the spine fall down.

The present invention concerns the field of book and sheet binding machines and in particular it concerns an automatic book and sheet trimming machine with combined-motion blades.

Automatic machines for trimming books, reams, paperbacks, etc. are known. These machines mainly comprise one or more movable tables that transport the books for the whole trimming process, a support table for the book to be trimmed and one or more trimming blade units.

Besides each blade there is a pressing element, that is, a rigid table that is translated vertically and keeps the various sheets pressed together near the cutting point. These pressing elements rest on and press the sheets just before the blades are operated.

A positioning device takes a book or set of sheets to be trimmed in correspondence with the spine and transfers it onto the table.

A first blade trims the edge opposite the spine and successively the book or set of sheets is trimmed also on the other sides by two parallel blades, each one of which is mounted on a guide in such a way as to perform a diagonal downward translation.

Said parallel blades trim the two upper and lower edges of the book, that is, the edges adjacent to the spine.

The known book and sheet trimming machines, however, present a series of drawbacks.

The movement of the two parallel blades is a diagonal downward translation. This movement keeps the blade cutting edge always parallel to itself on each point of the movement described by the blade, thus carrying out a cut that isn't always satisfactory.

To obtain a perfect cut it would be necessary that the downward travel of the part of the blade furthest from the spine be longer than the travel of the part of the blade nearest to the spine.

Another drawback concerns the reaction of the sheets when the pressing elements and the blades that cut the two upper and lower edges adjacent to the spine rest on them. In fact, when pressed on their outer edges, the sheets tend to be lifted at the centre. The thicker and wider the book or set of sheets to be trimmed is, the more the sheets are lifted at the centre.

A further drawback is represented by the fact that the trimmings resulting from previous trimming operations remain on the support table, thus hindering and interfering with the movement of the successive book or set of sheets, with obvious negative consequences.

In order to eliminate the above mentioned problems and drawbacks, a new book and sheet trimming machine with combined-motion blades has been designed and implemented.

The new trimming machine has the blades for trimming the edges adjacent to the spine mounted on rods with different configuration, so that the cutting edge carries out a composite movement, comprising an arced movement and a non-circular rotation.

The new trimming machine is provided with a new central device that exerts a uniform pressure on the upper surface of the book or set of sheets to be trimmed and is automatically adjusted according to the surface to be pressed.

The new trimming machine is also provided with devices to remove the trimmed parts of the sheets, which are constituted by overturning tables.

The main goal of the new trimming machine is to obtain a correct cut of the edges of the book or set of sheets.

Another goal of the new trimming machine is to ensure the perfect horizontality and squaring of all sheets during and after trimming.

Another aim of the new trimming machine is to remove completely the residues of the previous trimming before carrying on with the trimming of the successive book or set of sheets.

All the goals described above have been achieved through the implementation of a new trimming machine that is the subject of this patent and whose main parts are illustrated in the following description of one among many possible applications, making reference to the enclosed drawings.

FIGS. 1, 2, 3 are side views of the new machine, where it is possible to observe the front blade (L1) for trimming the edge of the book opposite the spine and one of the two parallel blades (L2) for trimming the edges of the book that are adjacent to the spine. The three figures show three main moments of the movement of the two parallel blades (L2).

It is possible to observe that the blade (L2) is hinged to two rods (B1, B2) that serve as connecting elements. One of said rods (B2) is connected (B2m) with the mechanism generating the movement of the blade (L2).

In particular, the hinge points (Br1, Br2) of the two rods (B1, B2) on the structure (M) of the machine don't lie on a line parallel to the support table (P), on the contrary, the rod (B1) has the hinge point (Br1) positioned lower than the hinge point of the rod (B2).

Owing to this arrangement and these hinge constraints, the blade (L2) carries out a composite movement: a translating movement describing an arc (X) and a rotation of the blade (L2) itself.

In the figures the distances have been emphasized in order to make the basic concept of the invention clearer.

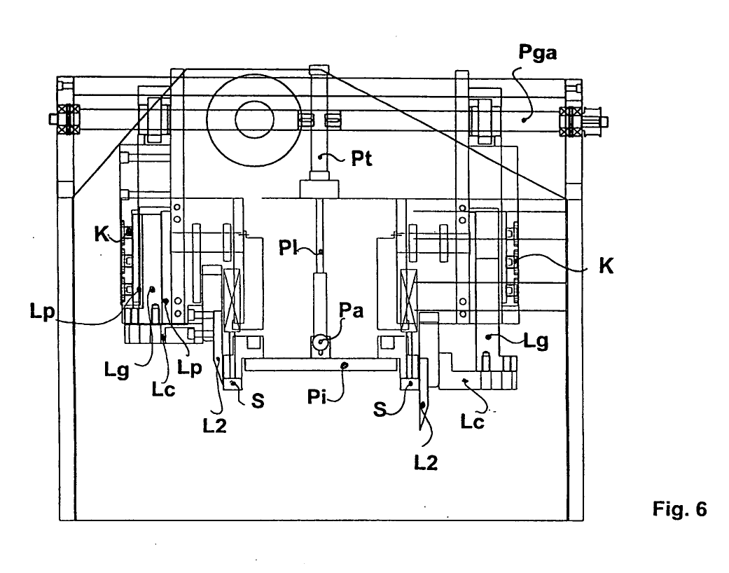

The rods of the two parallel blades (L2) are joined to the structure (M) of the machine by front (Pga) and rear (Pgp) guide pins (worm screws), shown in FIGS. 6 and 8, with double opposite thread, which permit the manual or automatic adjustment of the distance between the two parallel blades (L2), in such a way as to adapt it to the size of the books or set of sheets (F) to be trimmed.

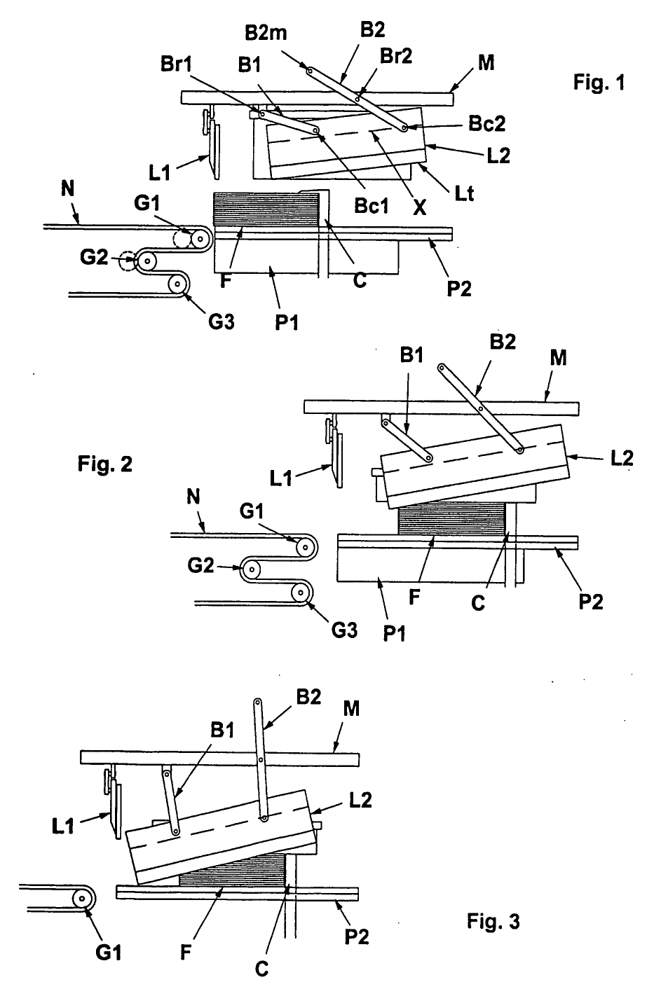

In the same figures it is possible to observe a device for the removal or elimination of the trimmings (F) resulting from the cutting of the edge the book (F) opposite the spine: in its front or terminal part, the conveyor belt (N) that transports the book or set of sheets (F) to the support table (P) slides around three rollers (G1, G2, G3), of which the two upper rollers (G1, G2) are translated in such a way as to bring the edge of the belt (N) near to or move it away from the support table (P) (see FIG. 1 and FIG. 2). In this way the edge of the conveyor belt (N) is brought near the support table (P) to move the book (F) onto the support table (P) itself and successively it is moved away from the same in such a way as to let the trimmings fall between the support table (P) and the edge of the belt (N) itself.

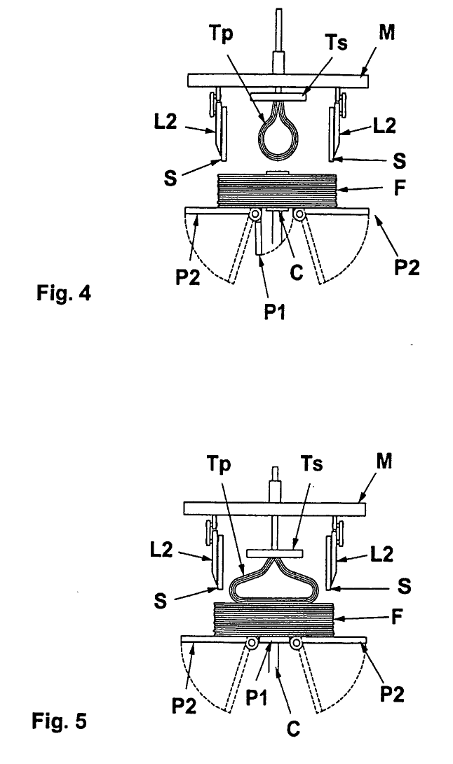

FIG. 4 is a front view of the new machine, in which it is possible to observe the support table (P), a positioning device (C) that transports the book and the two parallel blades (L2) for trimming the lower and upper edges of the book or set of sheets.

In this figure it is possible to observe the two pressing elements (S) besides the blades (L2), which have the function to keep the sheets of the book (F) pressed while they are being trimmed, the central pressing device (T) that presses the upper surface of the book (F) to be trimmed and the special shape of the support table (P).

The pressing device comprises a support (Ts) to which elastic elements are attached, for example, coupled layers of elastic material (Tp). These layers of elastic material (Tp) are constituted by rubber sheets coupled to each other and having the two edges parallel to the edges of the book (F) joined to each other and to the support (Ts), so that their cross section takes the shape of a drop.

Said pressing device (T) is lowered onto the book or set of sheets (F) (FIG. 5) before the operation of the parallel blades (L2). The vertical translation of the pressing device (T) is adjusted automatically and adapted to the size of the book or set of sheets (F).

When the layers of elastic material (Tp) are pressed onto the book or set of sheets (F), they adhere completely to the upper surface of the book or set of sheets (F), except for the side trimming margin.

Thus, when the pressing elements (S) press the edges of the book or set of sheets (F), the central part of the sheets cannot be lifted.

The support table (P) comprises three parts (P1, P2), one central (P1) and two lateral (P2). The three parts (P1, P2) of the support table (P) are hinged and their axis is parallel to the advance direction of the book or set of sheets (F).

The central part (P1) is usually lowered to allow the passage of the positioning device (C) that transports the books (F), but it is lifted and aligned with the other two lateral parts (P2) when the pressing device (T) is lowered and the blades (L1, L2) carry out the trimming operation.

The two lateral parts (P2) are kept in horizontal position for the whole period during which the book or set of sheets (F) is translated onto the table (P) and the blades (L1, L2) carry out the trimming, then said lateral parts (P2) of the table (P) are rotated downwards (broken line in the figure) in order to eliminate the trimmings owing to the effect of gravity and by blowing them away from the support table (P).

FIG. 6 shows an alternative implementation of the pressing device, comprising a piston (Pt) that moves the extension (P1) to which a coupling pin (Pa) is fixed. A plane (P1) that can be changed according to the size of the book or set of sheets is connected to said coupling pin (Pa). It is possible to observe the blades (L2) connected to the blade guides (Lg) sliding between two fixed side blocks (Lp) by means of the connecting cross element (Lc).

Said fixed side blocks guide the sliding movement of the blade guide and blade, thus ensuring a perfect cut.

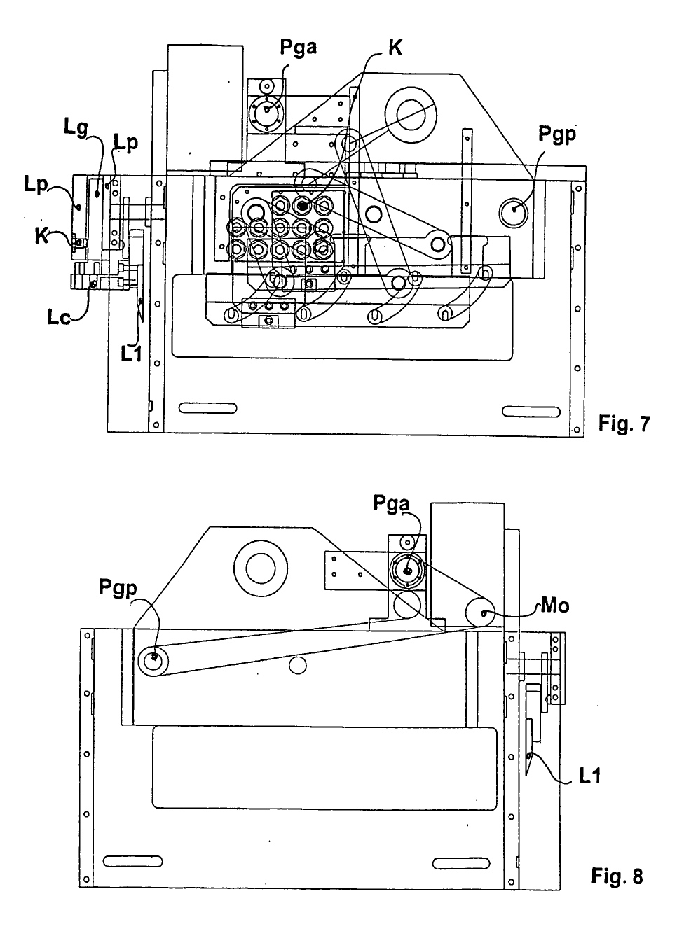

The external side block (Lp) can be adjusted by means of the pins (K) that permit the translation of said block to compensate for any wear of the parts. These pins (K) are visible also in FIG. 7, which shows the same solution adopted to guide the side blades (L2) applied also to the front blade unit (L1).

FIG. 6 shows also the front guide pin (Pga) suitable for translating the blade units (L2).

FIG. 8 shows the motor (Mo) that by means of the belts (Cg) transmits motion to the front guide pin (Pga) and to the rear guide pin (Pgp).

The above are the basic outlines of the invention, on the basis of which the technician will be able to put it into effect; any change which may be necessary upon implementation is to be regarded as completely protected by the present invention, provided that it is based on the same innovative concept described herein.

Therefore, with reference to the above description and to the attached drawings, the following claims are put forth.

1. Book trimming machine, characterized in that it comprises trimming blades (L1 and L2) fixed to blade carriers with connection through rods (B1 and B2) hinged at different distances from the cutting edge.

2. Book trimming machine, characterized in that it comprises trimming blades (L1 and L2) mounted on rods (B1 and B2) hinged at different heights with respect to the support table (P) on which the book (F) rests.

3. Book trimming machine according to claim 1, 2, characterized in that it is provided with a central pressing device to press the sheets of the book to be trimmed, constituted by a support (Ts) to which elastic or pneumatic elements (Tp) are attached, and wherein said pressing device is lowered onto the book before operating the blades and its travel is automatically adjusted according to the size of the book.

4. Book trimming machine according to claim 3, characterized in that the elastic elements (Tp) are constituted by coupled layers of elastic material, having the two edges parallel to the edges of the book joined to each other and to the support, so that their cross section takes the shape of a drop.

5. Book trimming machine according to claim 1, 2, characterized in that it is provided with central and front pressing devices to press the book sheets, comprising a piston (Pt) that translates the extension (P1) to which a coupling pin (Pa) is fixed.

6. Book trimming machine according to claim 5, characterized in that on said coupling pin (Pa) there is a pressing element (P1) that can be changed according to the size of the book.

7. Book trimming machine according to claims 4, 6, characterized in that it is provided with a positioning device (C) that holds and translates the book on the support table, and wherein said positioning device slides on a central slot of the support table.

8. Book trimming machine according to claim 7, characterized in that the positioning device (C) takes a book to be trimmed and then moves forward to bring the book (F) towards the trimming blades, pushing the previously trimmed book beyond the blades, releases the book once it has been trimmed, goes down, moves backwards, goes up and takes the following book to be trimmed.

9. Book trimming machine according to claims 4, 6, 7, 8, characterized in that the support table (P) is constituted by two hinged parts (P2) with horizontal axis near the path of the positioning device (C), and wherein the positioning device (C) slides between said two parts of the support table, and wherein said two parts of the support table are kept in horizontal position for all the time during which the book is translated on the table; and in that, after the blades have carried out the trimming operation, said two parts are rotated downwards in order to remove the trimmings owing to the effect of gravity or by blowing them away.

10. Book trimming machine according to claims 4, 6, 9, characterized in that it is provided with a hinged central overturning plane (P1) with axis parallel to the advance direction of the books, included between the two side parts of the support table, and wherein said central overturning plane is usually lowered to allow the passage of the positioning device (C) that transports the books, but is lifted and aligned with the two side parts of the support table when the blades trim the book.

11. Book trimming machine according to claims 4, 6, 10, characterized in that the front part of the conveyor belt (N) that transfers the book onto the support table slides around three rollers (G1, G2, G3), of which the two upper rollers (G1, G2) are translated in such a way as to bring the edge of the belt near to or move it away from the support table, and wherein the edge of the conveyor belt is brought near the support table to transfer the book onto said table and is then moved away from it in order to let the trimmings of the book edge opposite the spine fall down between the support table and the edge of the belt itself.

12. Book trimming machine according to claims 4, 6, 8, 9, 10, 11, characterized in that each of said blades (L1 and L2) is connected, through at least one connecting cross element (Lc), to blade guides (Lg) that slide between two fixed side blocks (Lp) that guide the sliding of the blade guide (Lg) and the blade (L1 and L2), thus ensuring a perfect cut.

13. Book trimming machine according to claim 11, characterized in that at least one of said side blocks (Lp) can be adjusted by means of pins (K) that allow said blocks (Lp) to be translated to compensate for any wear of the parts.

14. Book trimming machine according to claims 4, 6, 9, 10, 11, 12, 13, characterized in that it is provided with at least two guide pins (Pga, Pgp) of the blade units, and wherein said pins are set rotating by one or more motors (Mo).
